(19) United States
(12) Patent Application Publication
(10) Pub. No.: US 2025/0354385 A1
(43) Pub. Date: Nov. 20, 2025

(54) ENGINEERED WOOD VENTED SOFFIT WITH INTEGRATED FIRE-EMBER AND SNOW SCREEN

(71) Applicant: LOUISIANA-PACIFIC CORPORATION, NASHVILLE, TN (US)

(72) Inventors: G. PAUL MERRICK, GIG HARBOR, WA (US); C W MACOMBER, JACKSONVILLE, FL (US); BENJAMIN BARRETTE, FRANKLIN, TN (US)

(21) Appl. No.: 19/208,345

(22) Filed: May 14, 2025

Related U.S. Application Data
(60) Provisional application No. 63/647,093, filed on May 14, 2024.

(51) Int. Cl. E04D 13/152; A62C 3/02; E04D 13/158

(52) U.S. Cl. CPC E04D 13/152; A62C 3/0214; E04D 13/158

(57) ABSTRACT

A pre-vented soffit panel with an integrated screen to exclude wind-blown embers from entering the attic space. Vent holes are created in the soffit, and a screen is integrated therewith, in the factory or on a production line. The screen material is fire-resistant. The pre-vented soffit panel with integrated screen can then be packaged and shipped to a job or construction site, and installed instead of, or in place of, a prior-art soffit panel. The integrated soffit screen also prevents the intrusion of wind-blown snow and several types of insects. This integrated solution provides for more rapid and cost-effective job site installation without the need to perform costly retrofitting of metal vents into prior-art soffit panels.

This application claims benefit of and priority to U.S. Provisional App. No. 63/647,093, filed May 14, 2024, which is incorporated herein its entirety by specific reference for all purposes.

### FIELD OF INVENTION

This invention relates to an engineered wood vented soffit product with integrated fire resistance and an integrated screen to prevent the entry of fire embers, snow, and/or insects.

### BACKGROUND OF INVENTION

In home construction, the eaves 2, or area or space underneath the portion of the roof overhanging or extending beyond the exterior of the wall, are often left open, with venting for the attic space provided by air flow between the joists, typically through holes 4 cut through or into the blocking (see FIGS. 1A and 1B). Alternatively, a soffit panel 6 may be installed where the roof overhangs the exterior wall to form a “boxed-in” or closed eave (see FIG. 1B). After the soffit is in place in the field (at the job site), vent holes are then cut into the soffit, and a metal or plastic framed screen vent 8 fitted into the opening (see FIG. 2).

Model codes in Wildland-Urban Interface fire-prone areas are prohibiting the use of open eaves or roof overhangs. These codes are requiring the used of a “boxed-in” eave. A primary source of house fires during a wildfire event has been identified as the intrusion of burning embers 10 (i.e., burning material and debris) into the attic or other space in the house through the vents This may occur well in advance of the flame front of the wildfire, as the embers are conveyed by strong winds typically associated with the wildfire (see FIG. 3). Once in the attic space, embers can smolder for an extended period of time, with a fire not developing until well after the direct risk of combustion from the wildfire.

Accordingly, what is needed is an improved soffit panel to prevent the entry of embers into an attic or other space in the house.

### SUMMARY OF INVENTION

In various exemplary embodiments, the present invention comprises a pre-vented soffit panel with an integrated screen to exclude wind-blown embers from entering the attic space. In the context of the present invention, “pre-vented” means that vent holes are created in the soffit, and a screen is integrated therewith, in the factory or on a production line. The pre-vented soffit panel with integrated screen can then be packaged and shipped to a job or construction site, and installed instead of, or in place of, a prior-art soffit panel. The integrated soffit screen also prevents the intrusion of wind-blown snow (which can enter the attic and later melt, introducing moisture and water) and several types of insects. This integrated solution provides for more rapid and cost-effective job site installation without the need to perform costly retrofitting of metal vents into prior-art soffit panels. Such metal vents require the use of costly fire-rated caulks to ensure a complete seal with the soffit. As well, they represent a costly and potentially dangerous maintenance item for a homeowner as they can be located several stories above the ground.

The screen material is fire resistant, and also may be weather-resistant over the life of the installation as soffits and screens are only partially protected and will be exposed to the weather. In an exemplary embodiment, the screen is a woven metal-based wire mesh screen (also known as cloth or wire cloth), comprised of, but not limited to, galvanized steel, stainless steel, coated steel (e.g., zinc-aluminum alloy), or copper.

The mesh is sized to exclude blowing embers. One-quarter inch screens are not effective to prevent the passage of embers. In one exemplary embodiment, the mesh size is ⅛ inch or smaller. In a preferred embodiment, the mesh size is 1/16 inch or smaller.

The fire resistance of the soffit with integrated screen may be enhanced by application of a fire-resistant (FR) coating to the screen and/or to the soffit substrate (e.g., the back face, the front face, or both faces, and/or edges), the use of a soffit substrate with FR materials incorporated therein, the application of a FR material or layer (e.g., placed between the soffit substrate and the screen), or combination thereof.

### BRIEF DESCRIPTION OF THE DRAWINGS

FIGS. 1A-B show examples of attic vent designs with and without soffit panels.

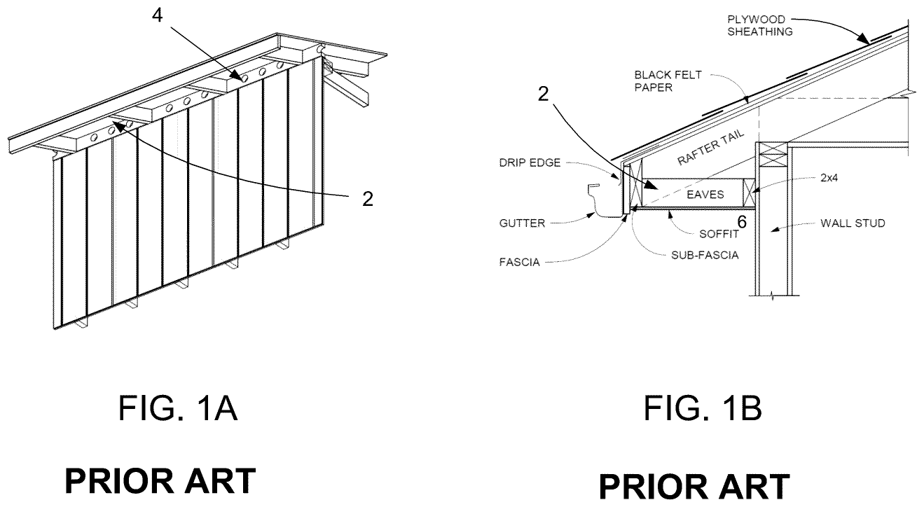

FIG. 2 shows examples of soffit vent screens on home construction.

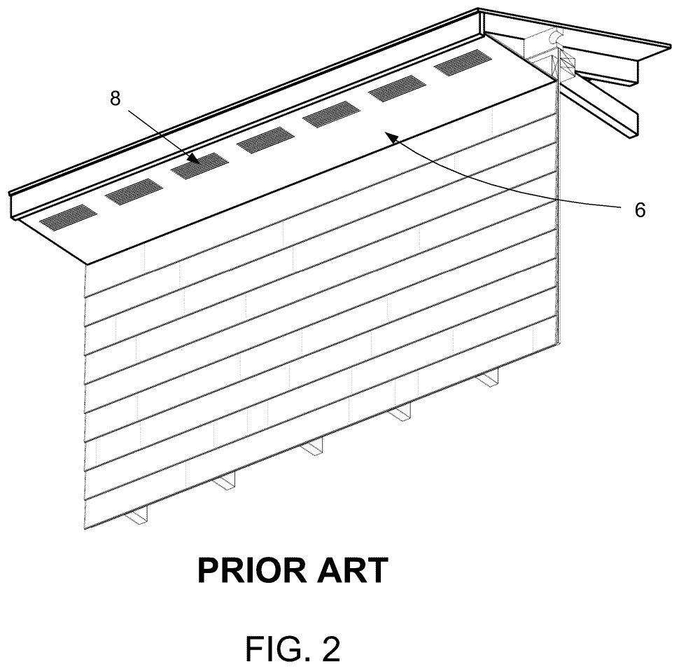

FIG. 3 shows a diagram of burning debris and embers moving ahead of a wildfire frame front.

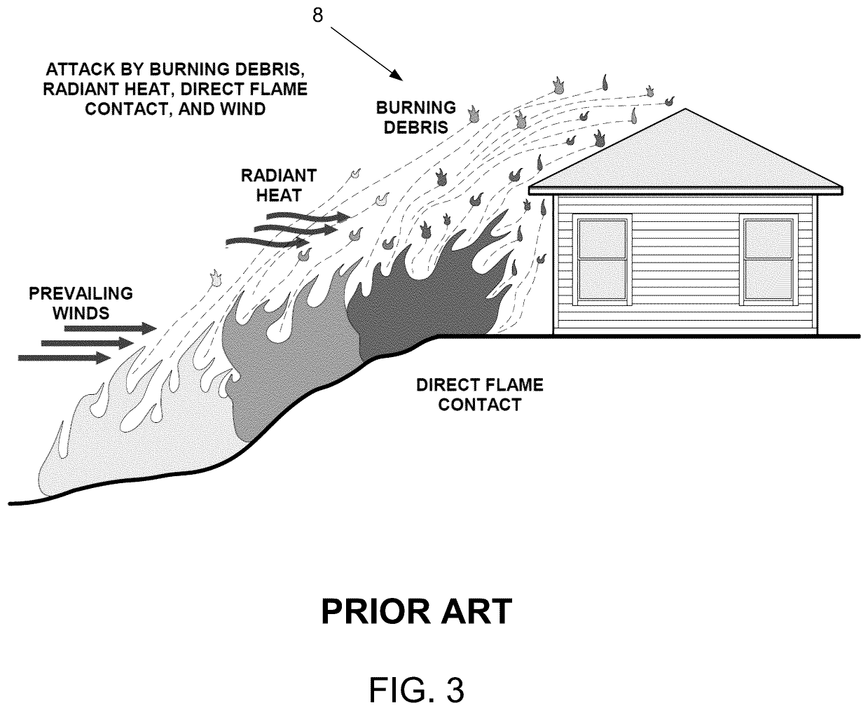

FIG. 4 shows a back perspective view of a section of engineered wood pre-cut vented soffit with pre-cut, slot- and/or slat-style vents, with an FR-coated screen, in accordance with an exemplary embodiment of the present invention.

FIG. 5 shows an example of the front view (the bottom, outward-facing visible side) of a section of an engineered wood vented soffit with pre-cut, slot- and/or slat-style vents with an integrated wire mesh screen.

FIG. 6 shows an example of the back side view of the section of engineered wood vented soffit of FIG. 5.

FIG. 7 shows a cross sectional view of the soffit of FIG. 5.

FIG. 8 shows a close-up front face view of a single vent area from FIG. 5.

FIG. 9 shows a close-up back face view of FIG. 8.

FIG. 10 shows a back perspective view of a section of engineered wood pre-cut vented soffit with pre-cut, round hole perforated style vents, with an FR-coated screen, where the perforations are in rectilinear sections.

FIG. 11 shows a back perspective view of a section of engineered wood pre-cut vented soffit with pre-cut, round hole perforated style vents, with an FR-coated screen, where the perforations are a continuous linear section.

FIG. 12 shows an example of the back side view of the section of engineered wood vented soffit of FIG. 10.

FIG. 13 shows an example of the back side view of the section of engineered wood vented soffit of FIG. 11.

FIG. 14 shows a close-up back face view of FIG. 12.

FIG. 15 shows a close-up back face view of FIG. 13.

FIG. 16 shows an example of the steps of production of a screened vented soffit with a fire-resistant (FR) layer between the soffit substrate (e.g., a coating on the soffit substrate) and the integrated wire mesh screen, where the screen fully covers the substrate.

FIG. 17 shows an example of the steps of production of a screened vented soffit with a fire-resistant (FR) layer between the soffit substrate and the integrated wire mesh screen, where the screen is a strip covering the vents.

FIG. 18 shows an example of the steps of production of a screened vented soffit with a fire-resistant (FR) treated integrated wire mesh screen, where the screen fully covers the substrate.

FIG. 19 shows an example of the steps of production of a screened vented soffit with a fire-resistant (FR) treated integrated wire mesh screen, where the screen is a strip covered the vents.

FIG. 20 shows a perspective view of a screened vented soffit with perforated vents with a coating or fabric (which may or may not be fire resistant) applied to the back face of the soffit substrate, with an integrated wire mesh screen (which may or may not be coated with a fire resistant coating) where the screen is a strip covering the vents.

FIG. 21 is a back view of FIG. 20.

FIG. 22 shows a perspective view of a screened vented soffit with a continuous perforated strip extending lengthwise, with a coating or fabric (which may or may not be fire resistant) applied to the back face of the soffit substrate, with an integrated wire mesh screen (which may or may not be coated with a fire resistant coating) where the screen is a strip covering the line of perforations.

FIG. 23 is a back view of FIG. 22.

FIG. 24 shows a close-up back face view of a metal for FR-resistant cloth or fabric mesh with circular openings, used in conjunction with a slotted vent configuration.

### DETAILED DESCRIPTION OF EXEMPLARY EMBODIMENTS

In various exemplary embodiments, the present invention comprises a pre-vented soffit panel 20 with an integrated screen 30 configured to exclude wind-blown embers from entering the attic space. The integrated soffit screen also prevents the intrusion of wind-blown snow (which can enter the attic and later melt, introducing moisture and water) and several types of insects. This integrated solution provides for more rapid and cost-effective job site installation without the need to perform costly retrofitting of pre-made metal vents. Such pre-made metal vents require the use of expensive fire-rated caulks to ensure a complete seal with the soffit. As well, pre-made metal vents represent a costly and potentially dangerous maintenance item for a homeowner as they can be located several stories above the ground.

The screen 30 material of the present invention is fire resistant, and also may be treated or configured to provide weather-resistance over the life of the installation. as the vented soffit and screen are only partially protected and will be exposed to the weather. In an exemplary embodiment, the screen is a woven metal-based wire mesh screen (also known as cloth or wire cloth), comprised of, but not limited to, galvanized steel, stainless steel, coated steel (e.g., zinc-aluminum alloy), or copper.

The mesh is sized to exclude blowing embers. One-quarter inch screens are not effective to prevent the passage of embers. In one exemplary embodiment, the mesh opening size (length or diameter) is ⅛ inch or smaller, or no more than ⅛ inch. In a preferred embodiment, the mesh opening size is 1/16 inch or smaller, or no more than 1/16 inch. The mesh openings thus may be sized to prevent the passage of more than half of all embers that come into contact with the screen, more preferably more than 75% of all embers that come into contact with the screen, even more preferably more than 90% of all embers that come into contact with the screen, and most preferably more than 99% of all embers, or all or substantially all, of all embers that come into contact with the screen.

The fire resistance of the soffit with integrated screen may be enhanced by the application of a fire-resistant (FR) coating to the screen and/or to the soffit substrate (e.g., the back face, the front face, or both faces, and/or edges), the use of a soffit substrate with FR materials incorporated therein, the incorporation or application of a FR material or layer (e.g., an FR material or layer placed between the soffit substrate and the screen), or a combination thereof.

Examples of FR coatings for a soffit panel include, but are not limited to, a cementitious coating, a MgO-based coating, an intumescent coating, and the like. A cementitious coating containing magnesium oxychloride for coating and protecting wood is described in U.S. Pat. No. 7,595,092 (Huddy, et al.); a coating for wood that contains expandable graphite in a compound containing both a thermoplastic and thermoset binder and blowing agent is described in U.S. Pat. No. 10,533,097 (Lai, et al.); and a fire retardant intumescent coating that contains expandable graphite, a phosphorus compound and an polyamine resin is described in U.S. Pat. No. 8,808,850 (Dion, et al.); all of which are incorporated herein in their entireties by specific reference for all purposes. Dion further describes preparing a laminate that can be applied to a wood-based surface.

Intumescent coatings swell up when hit by direct flames. In the present invention, the swelling can help reduce the size of the vent holes or slots, or close them entirely. U.S. Pat. No. 7,413,024 (Simontacchi, et al.), a continuation-in part of U.S. Pat. No. 7,191,845 (Loar), describes self-closing vents that utilize an intumescent coating for the protection of a wire mesh/cloth screen, and a honeycomb screen housed in a metal frame with a 5 to 15 mil thick paint-type coating containing ammonium polyphosphate. A fire screen with intumescent coating produced from saturated solutions of liquid sodium silicate mixed with sodium bicarbonate for interior vents between rooms is disclosed in U.S. Pat. No. 2,279,791 (Lamb). A flame-spread reducing coating that contains a silicate binder (e.g. a sodium silicate, a potassium silicate), alumina trihydrate and kaolin is described in U.S. Pat. No. 7,652,087 (Dimanshteyn, et al.). U.S. Pat. Nos. 7,413,024; 7,191,845; 7,652,087; and 2,279,791 are all incorporated herein in their entireties by specific reference for all purposes.

While some of the figures show round holes with the coating applied, in several embodiments the holes are cut as square in the soffit substrate; the cementitious coatings and/or intumescent coatings fill in the corner of the squares when applied, thereby producing the circular, round holes seen.

As mentioned above, FR materials or additives may be added to and/or incorporated into the engineered wood, including, but not limited to, oriented-strand board (OSB), that may be used for the soffit substrate of the present invention. Engineered wood is a product alternative to natural solid wood lumber is that these materials exhibit properties like those of the equivalent natural solid wood lumber, especially, the properties of retaining strength, durability, stability, and finish under exposure to expected environmental and use conditions. A class of alternative products are multilayer oriented wood strand particleboards, particularly those with a layer-to-layer oriented strand pattern, such as oriented-strand board (OSB). Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. No. 3,164,511 (Elmendorf, issued Jan. 5, 1965), U.S. Pat. No. 4,364,984 (Wentworth, issued Dec. 21, 1982), U.S. Pat. No. 5,425,976 (Clarke, et al., issued Jun. 20, 1995), U.S. Pat. No. 5,470,631 (Lindquist, et al., issued Nov. 28, 1995), U.S. Pat. No. 5,525,394 (Clarke, et al., issued Jun. 11, 1996), U.S. Pat. No. 5,718,786 (Lindquist, et al., issued Feb. 17, 1998), and U.S. Pat. No. 6,461,743 (Tanzer, et al., issued Oct. 8, 2002), all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

Examples of the use of FR-treated OSB and other forms of engineered wood that may be used for the soffit substrate of the present invention, are disclosed in U.S. Pat. No. 12,123,200 (issued Oct. 22, 2024), published as U.S. Pub. No. 2020-0270871 (published Aug. 27, 2020)) (disclosing a FR-treated manufactured-wood based siding face layer); U.S. patent application Ser. No. 17/747,930 (filed May 18, 2022), published as U.S. Pub. No. 2022-0372749 (published Nov. 24, 2022) (disclosing methods of FR-treating strands, layers, and overlays during production of OSB); U.S. patent application Ser. No. 18/097,048 (filed Jan. 13, 2023) published as U.S. Pub. No. 2023-0219327 (published Jul. 13, 2023) (disclosing FR-treated siding and trim); and U.S. patent application Ser. No. 18/109,036 (filed Feb. 13, 2023), published as U.S. Pub. No. 2023/0256648 (published Aug. 17, 2023) (disclosing a method of manufacturing a fire-retardant tread wood composite panel, such as OSB, with low melting point fire retardant material by reducing the press temperature to below the melting point or softening temperature of the fire retardants used); all of which are incorporated herein in their entireties by specific reference for all purposes.

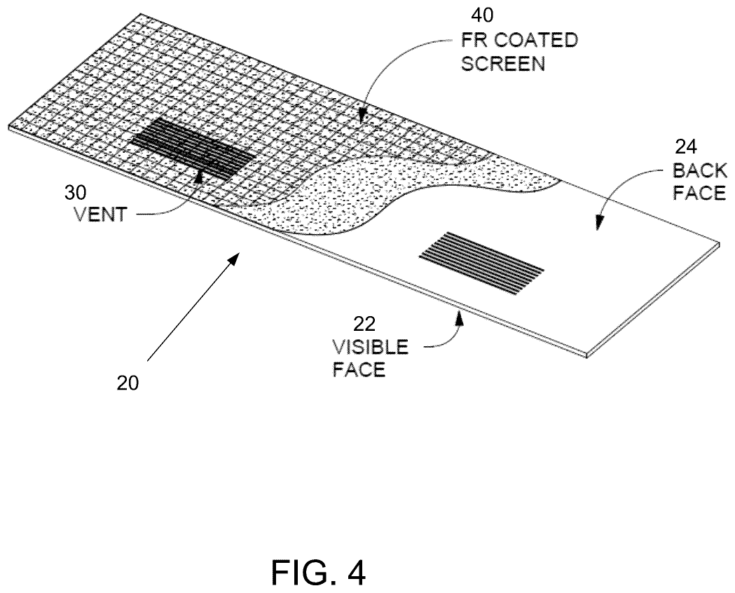

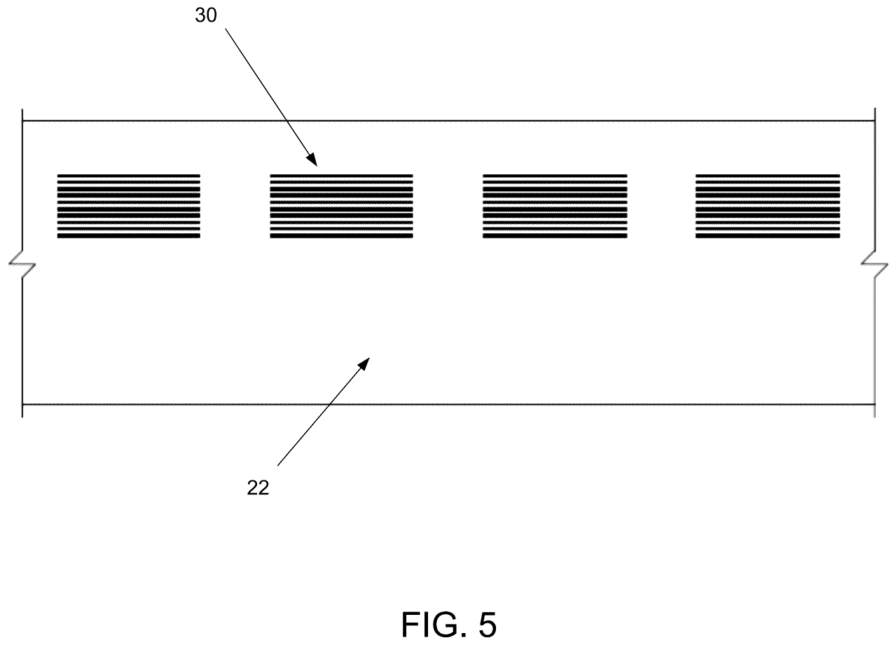

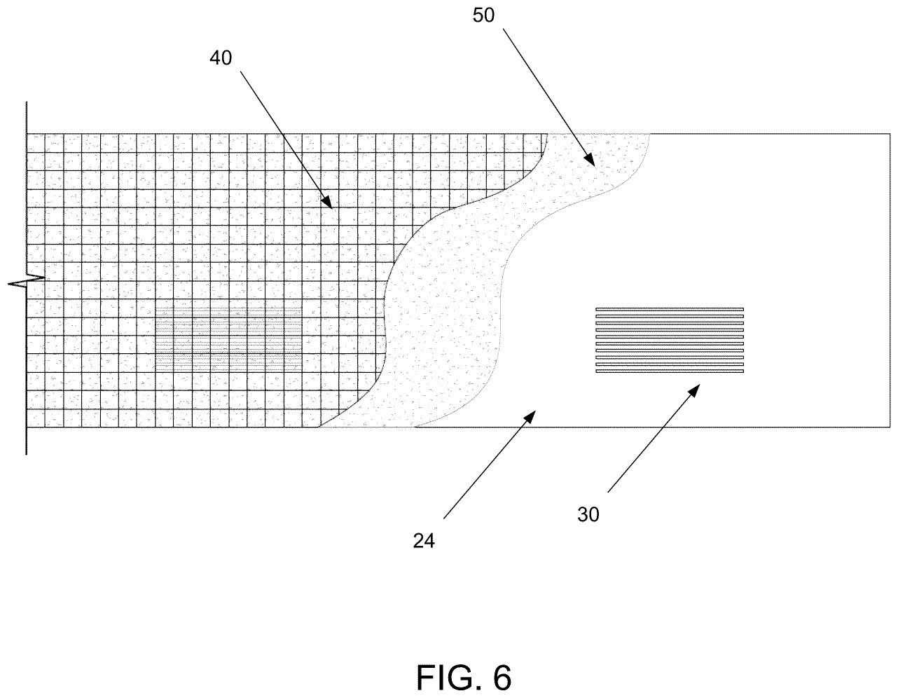

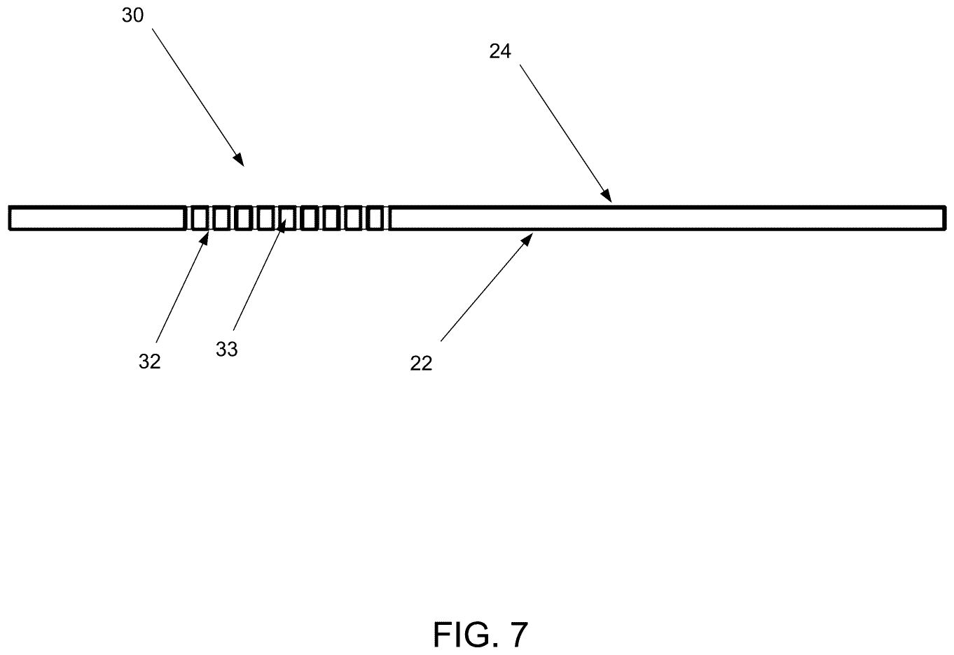

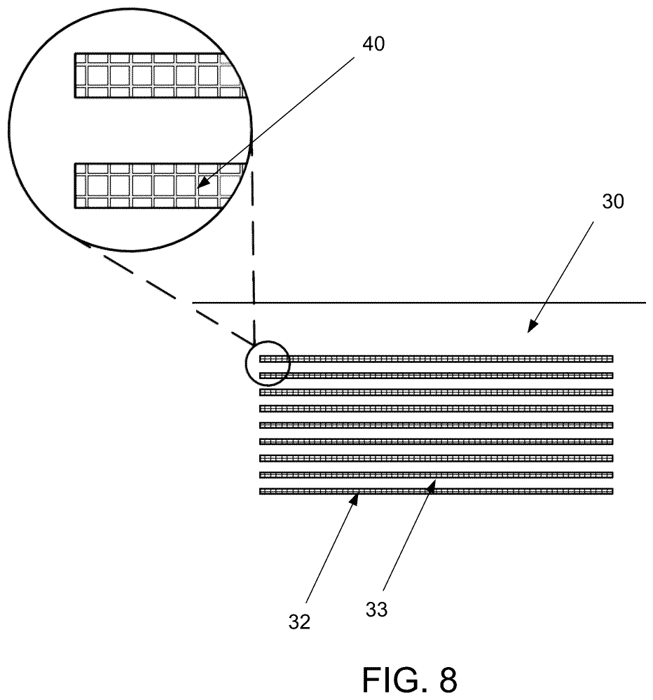

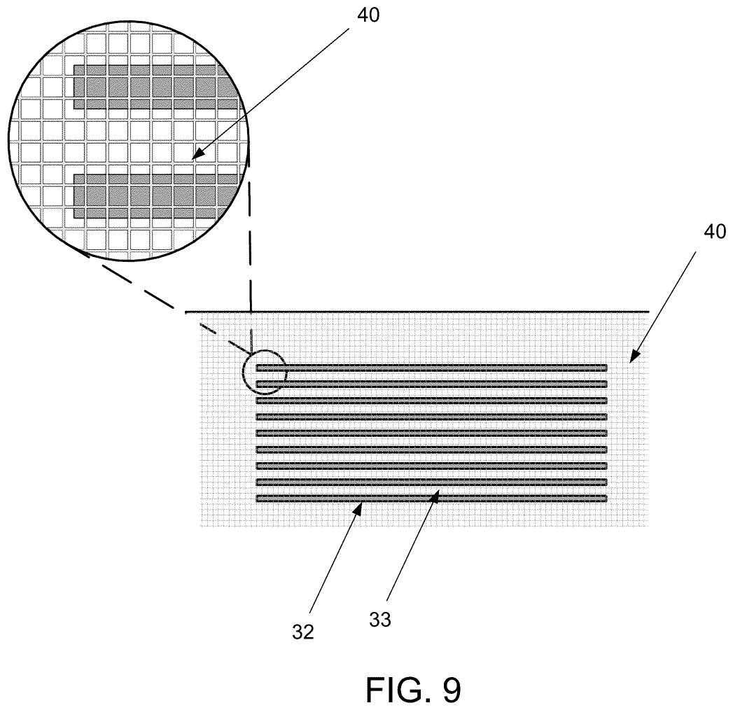

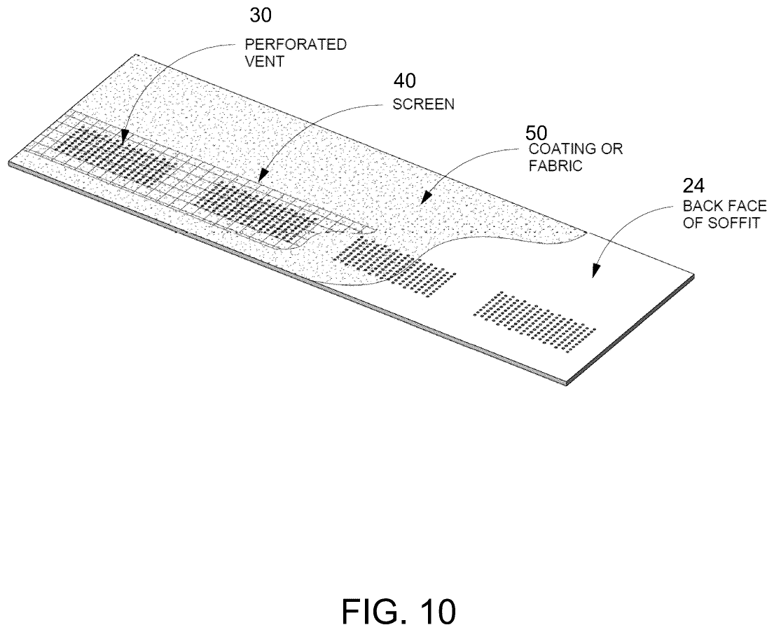

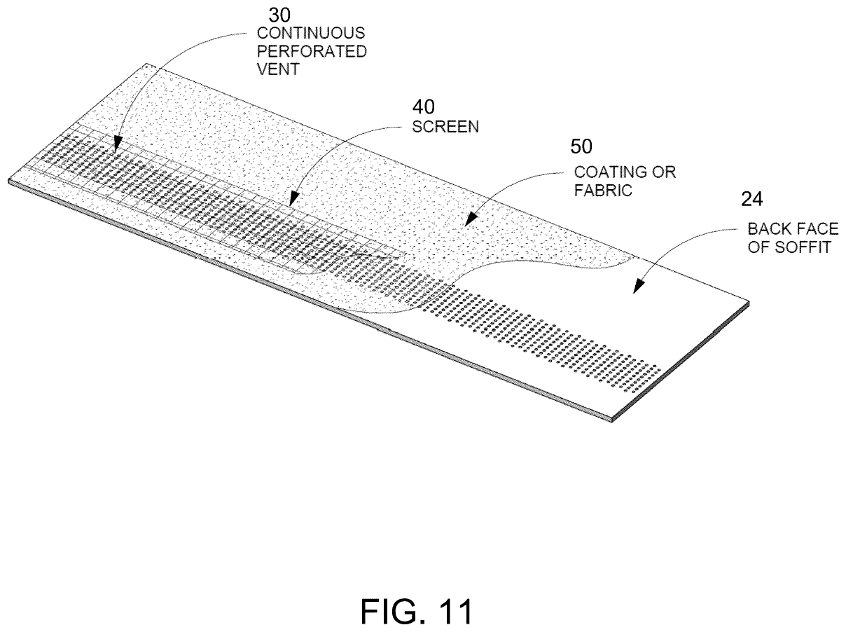

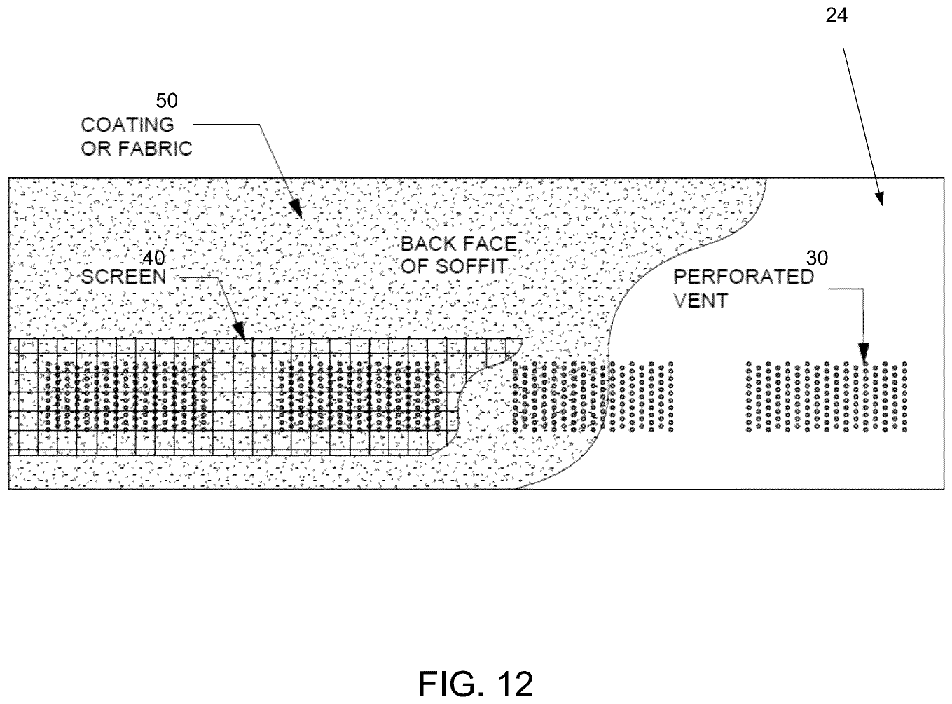

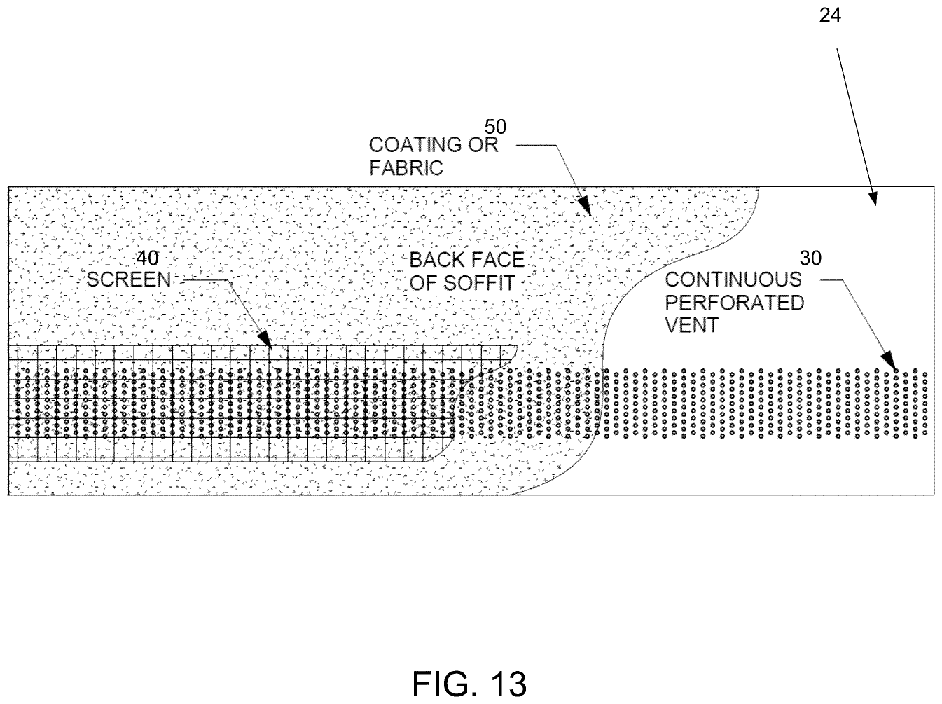

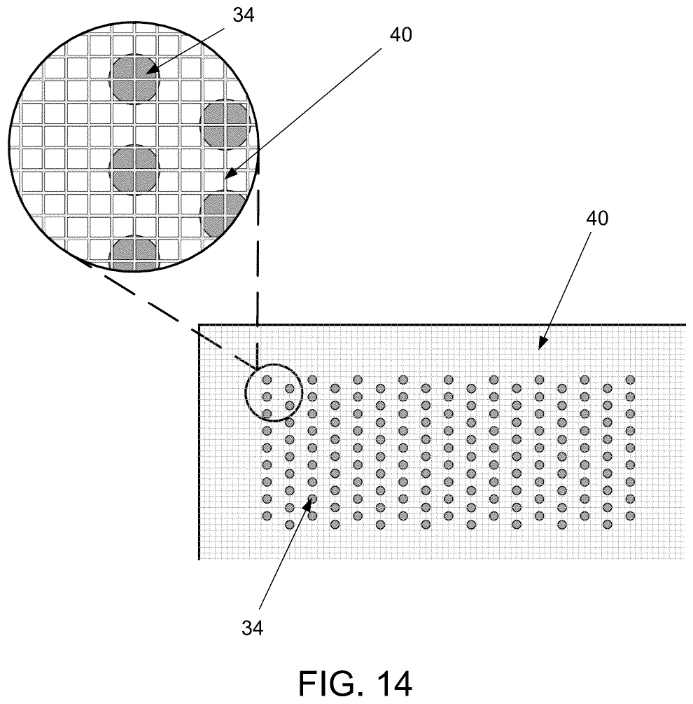

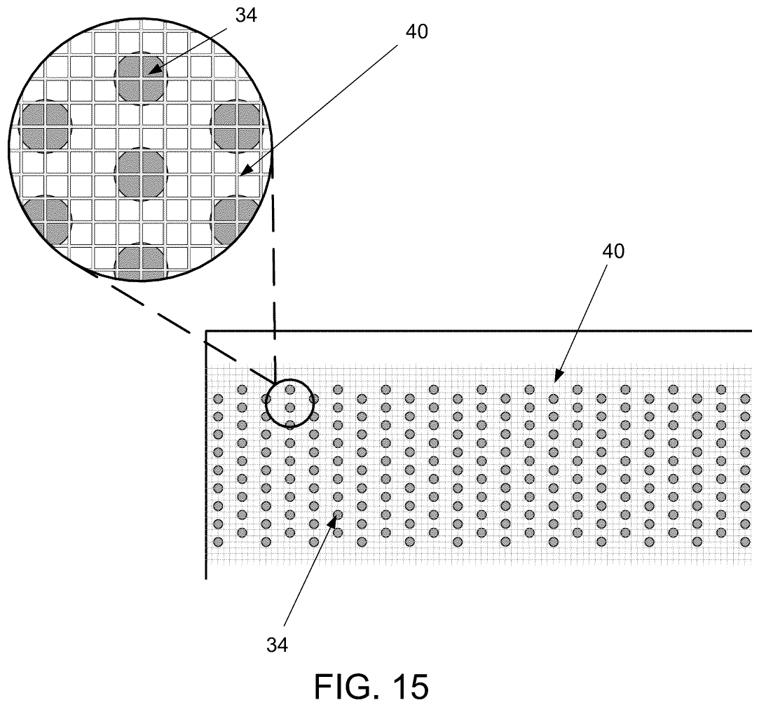

FIGS. 4-15 show examples of an engineered-wood vented soffit 20 (with a lower visible face 22 and an upper, inward-facing back face 24) with integrated vent 30 and wire mesh screen 40, and in some exemplary embodiments, an FR material or layer 50 placed between the soffit substrate and screen. Instead of a large hole in which a separate plastic or steel vent is installed in the field, the soffit of the present invention comprises pre-cut, integrated vent slots 32, slats 32 or holes 34. In this context, “holes” are spaces, hollows or openings cut, drilled or otherwise formed in or through the soffit, regardless of shape (e.g., round, circular, elliptical, rectilinear, square, polygonal, and the like), “slots” are long, narrow holes or openings, which also may be referred to as “slits”, and slats are long horizontal or vertical bars with corresponding openings or spaces therebetween, often used to direct and/or control airflow through a vent. Slotted vents often include corresponding slats. The slots, slats or holes may be pre-cut into the soffit substrate in the factory or on a production line. The vent holes, slots, or slats may be continuous or discontinuous. The vent holes, slots or slats may be confined to a specific area that is repeated periodically, which helps maintain the strength and integrity of the soffit substrate by preserving several portions of the soffit substrate without holes or vents, which can structurally weaken the substrate. Soffits often are thin and subject to undesired flexing or bending during handling, and a large number of hole, slots or slats may overly weaken the soffit substrate. Alternatively, the holes, slots or slats may extend continuously as a strip. In various embodiments, the FR coating applied to the soffit panel may improve the rigidity and/or stiffness of the soffit to address these potential issues.

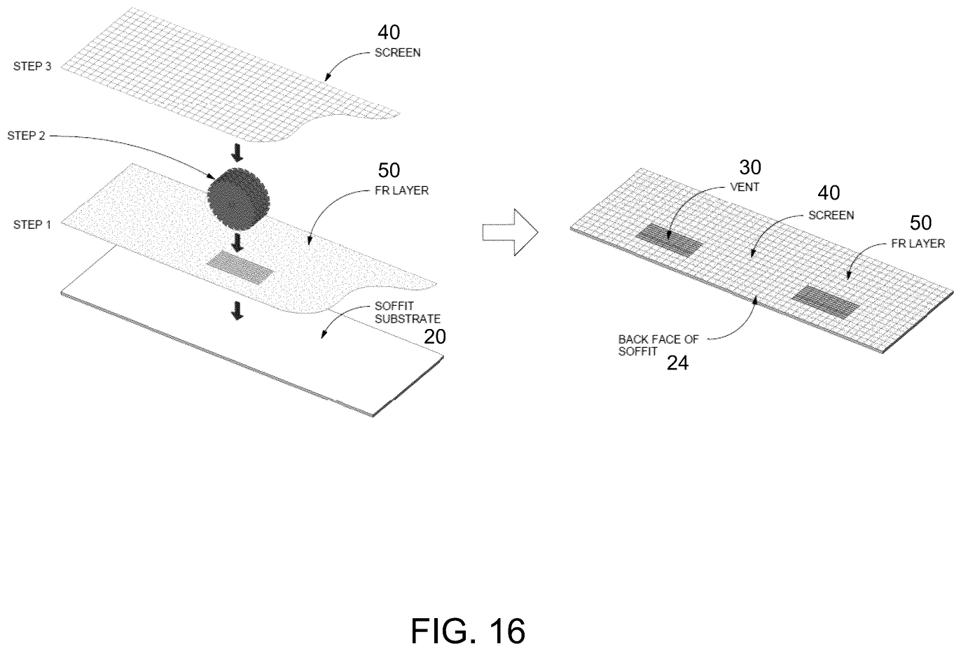

FIG. 16 shows an example of a method to produce an embodiment of the present invention. A rectilinear soffit substate is provided, and a FR layer is applied to the back face of the substrate. In a factory or on a production line, vent openings are cut through the substrate and FR layer by appropriate means (such as a multi-blade circular saw). In this example, the vent openings are periodic and rectilinear, with a plurality of linear slats or slots parallel to each other and the longitudinal axis of the substrate. A mesh screen is then applied over and adhered to the FR layer and substrate. The mesh screen may be attached by mechanical fasteners (such as, but not limited to, staples) or, more preferably, attached by an adhesive.

In the embodiment shown, the mesh screen covers the entire back surface of the soffit. While this embodiment requires more mesh screening be applied than if the mesh were covering only the vented area, the mesh screen covering the entire back surface enhances the integrity and strength of the soffit panel during a fire event, and will help prevent embers from entering the attic space through holes that may develop in other areas of the soffit away from the vents.

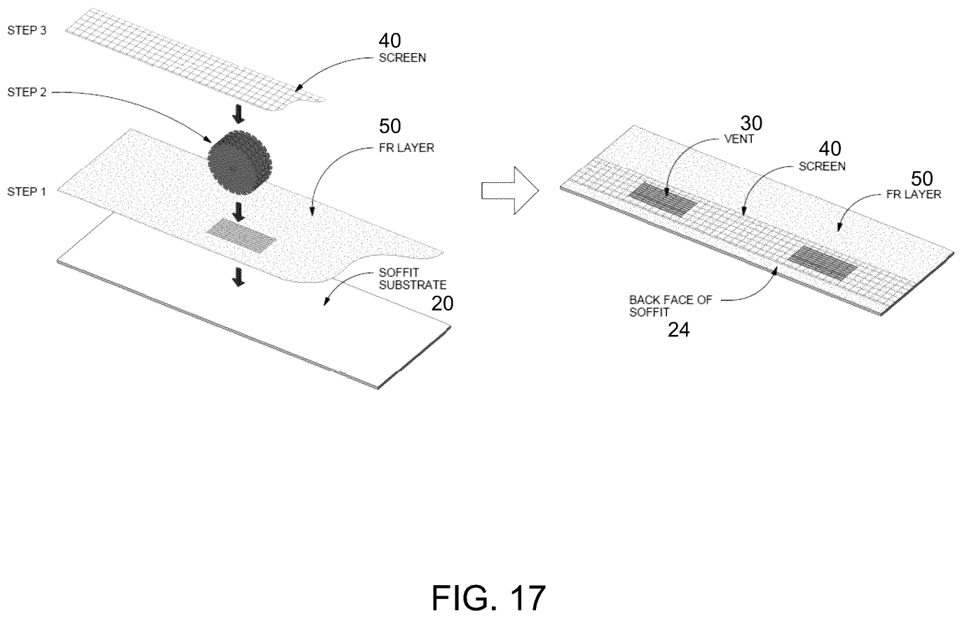

FIG. 17 shows another method similar to the example of FIG. 16, except that the mesh screen is applied as a strip that covers the vents but not the remainder of the back of the soffit. Alternatively, the mesh screen may be applied to the back as individual pieces sized to cover each vent and the immediately adjacent back area of the soffit.

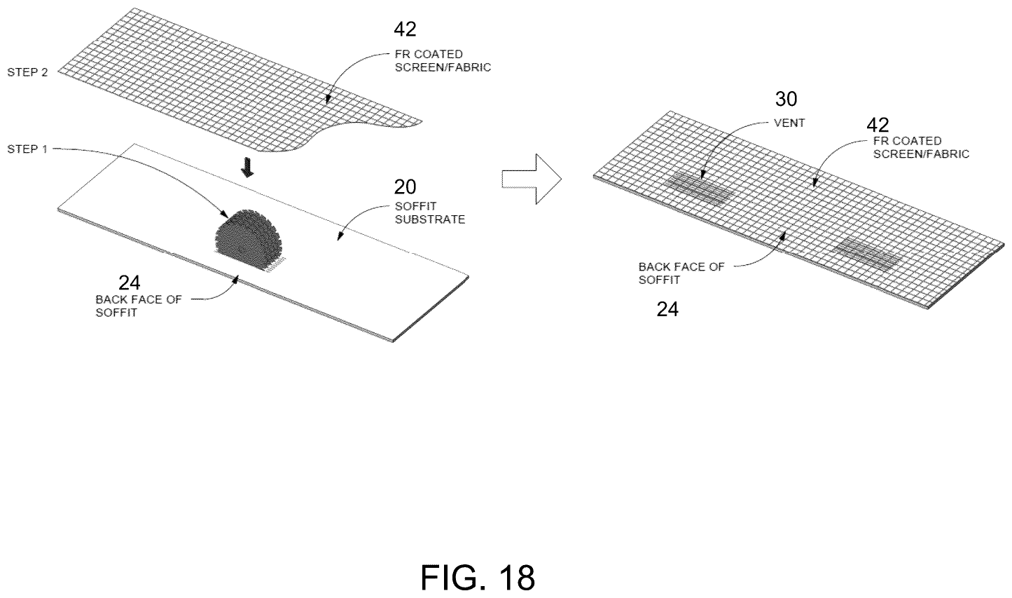

FIG. 18 shows a variation of FIG. 16, where the wire mesh screen has a FR treatment applied.

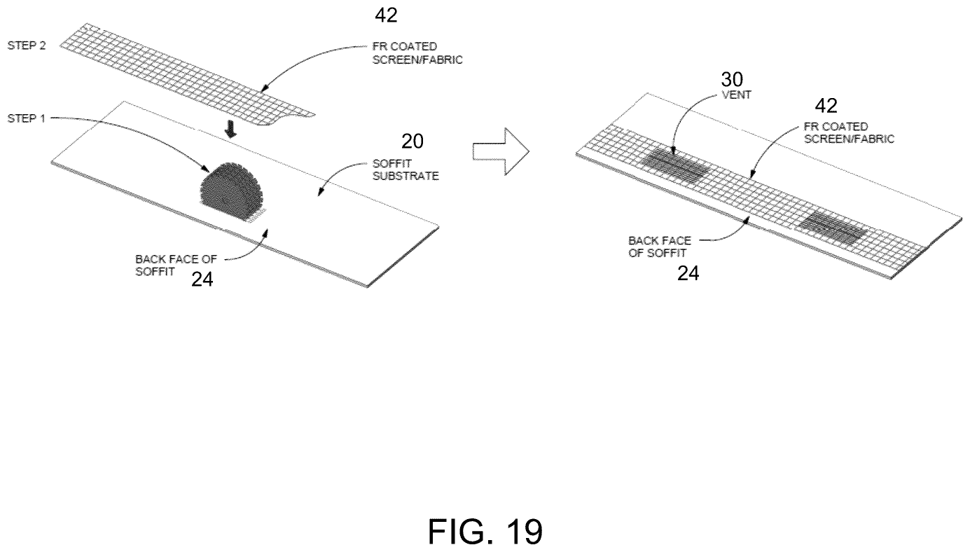

FIG. 19 shows a variation of FIG. 17, where the wire mesh screen has a FR treatment applied.

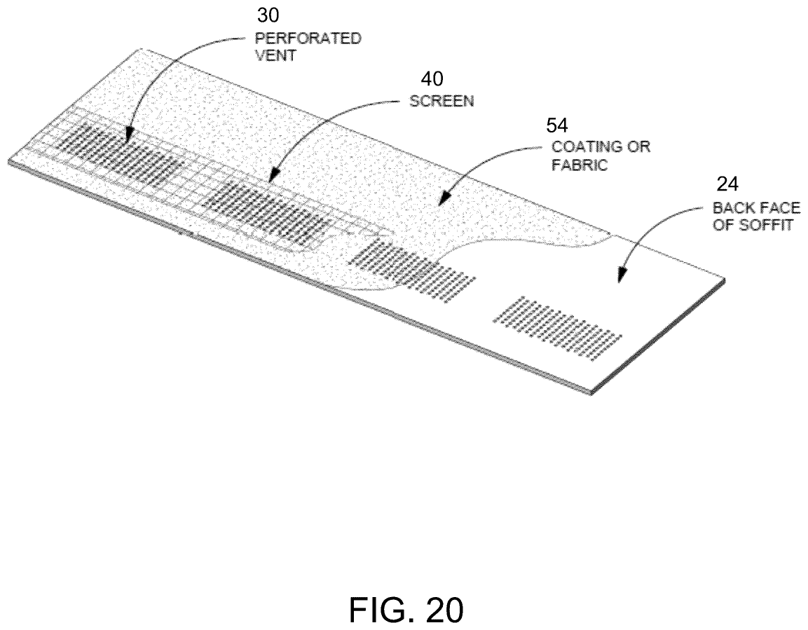

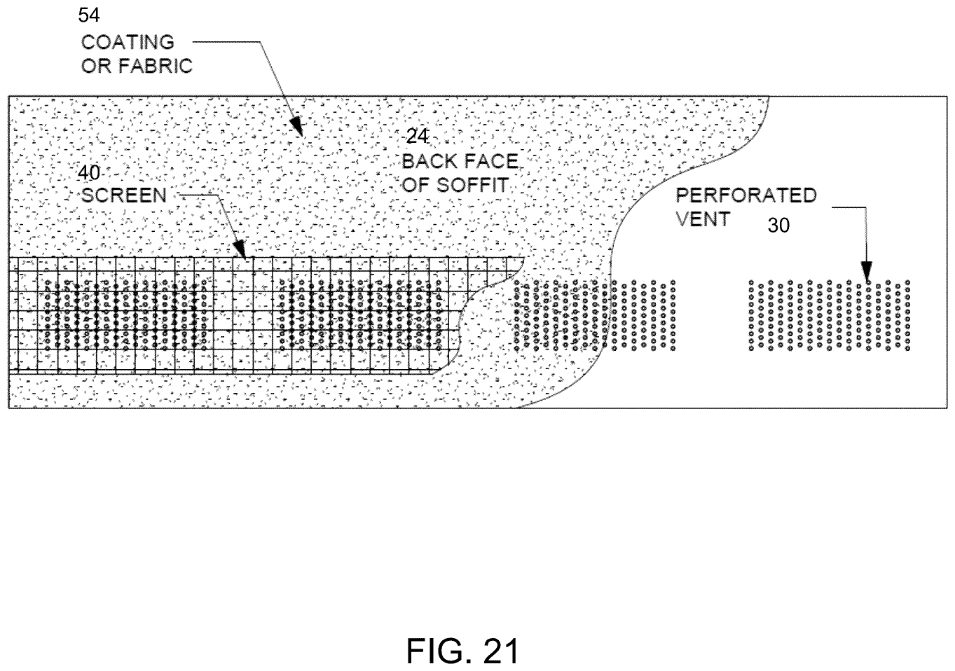

FIGS. 20 and 21 show views of a screened vented soffit with round, perforated vents with a coating or fabric 54 (which may be a FR coating or FR fabric) applied to the back face of the soffit substrate. The integrated wire mesh screen is a strip covering the vents.

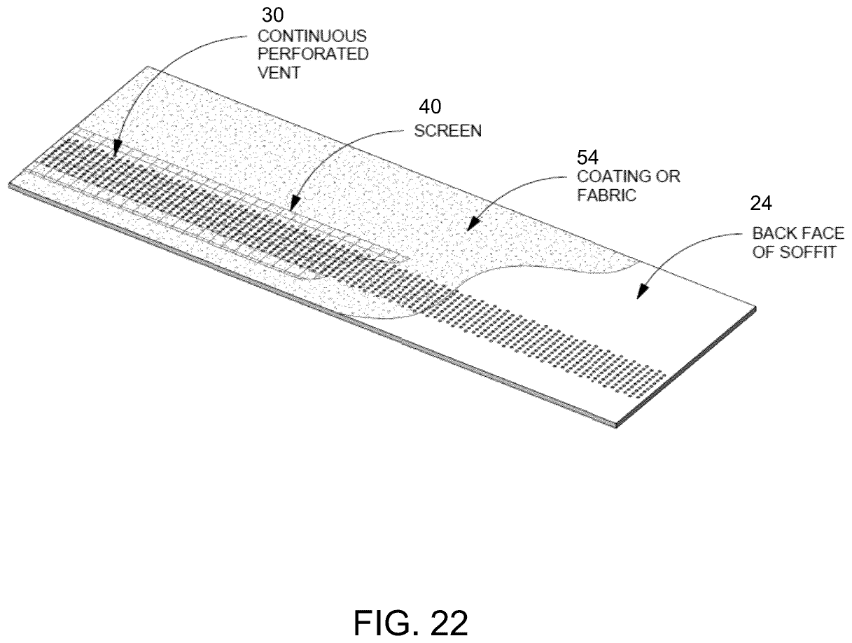

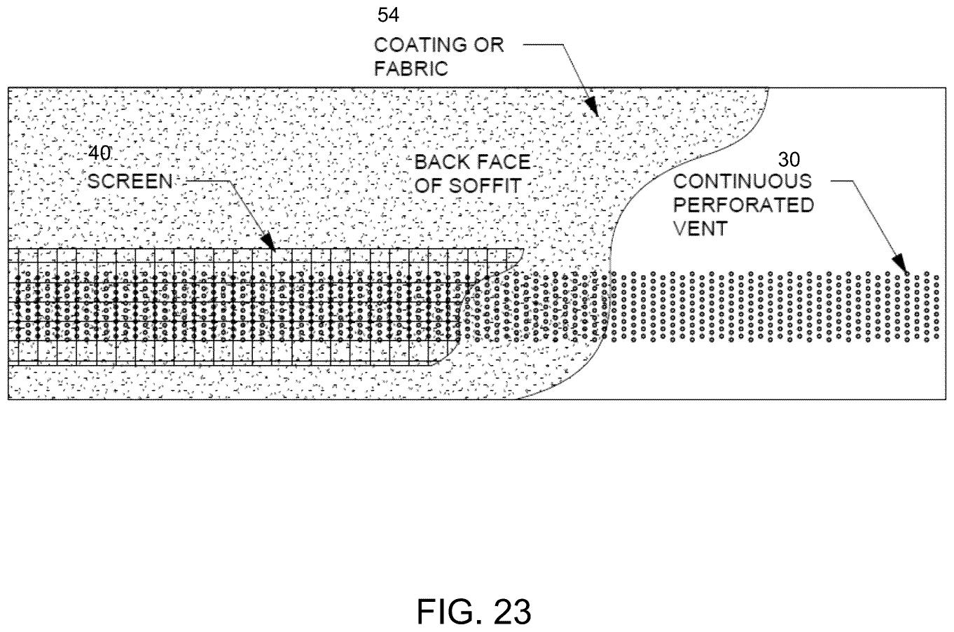

FIGS. 22 and 23 show views of a screened vented soffit with round, perforated vents with a coating or fabric 54 (which may be a FR coating or FR fabric) applied to the back face of the soffit substrate. The integrated wire mesh screen is a strip covering the line of perforations. The round perforation pattern as shown preserves greater strength and integrity in the soffit substrate as compared to extended linear slats and slots.

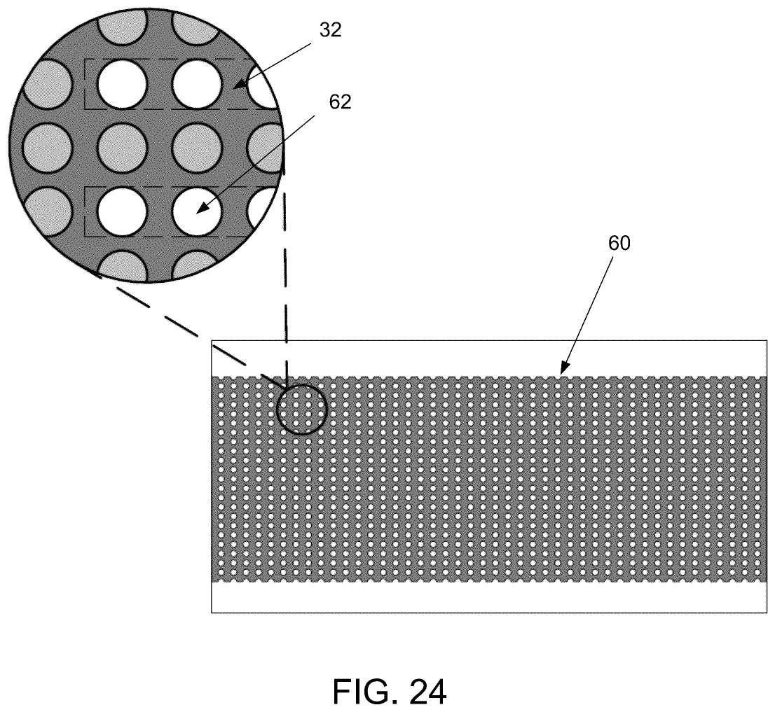

In several embodiments, the screen comprises a metal, cloth or fabric material 60 with a plurality of holes 62 therein, as seen in FIG. 24. The metal, cloth or fabric material may or may not be FR-treated, as described above, and may be used with combinations of vent configurations as described. For example, the screen 60 in FIG. 24 is used with a slotted 32 vent configuration. Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A fire-resistant soffit panel with integrated screen, comprising:
a soffit substrate with a back face and a front face;
at least one vent opening extending between the back face and the front face; and
an integrated screen extending across the at least one vent opening, wherein the screen is a metal wire mesh with a plurality of openings, wherein the mesh openings are sized to prevent the passage of blowing embers therethrough;
wherein the base soffit substrate, and the integrated screen are pre-formed into an integral multi-layer arrangement.

2. The soffit panel of claim 1, wherein the soffit substrate comprises manufactured wood.

3. The soffit panel of claim 1, wherein the soffit substrate comprises oriented strand board.

4. The soffit panel of claim 1, wherein the soffit substrate, the wire mesh, or both, have a fire-resistant treatment or coating applied thereto.

5. The soffit panel of claim 1, wherein the soffit substrate comprises a manufactured wood substrate incorporating fire-resistant treated material.

6. The soffit panel of claim 1, further comprising a fire-resistant layer, wherein the base soffit substrate, the fire-resistant layer, and the integrated screen are pre-formed into an integral multi-layer arrangement.

7. The soffit panel of claim 6, wherein the fire-resistant layer is disposed between the soffit substrate and the screen.

8. The soffit panel of claim 7, wherein the fire-resistant layer comprises one or more holes matching or encompassing the at least one vent opening.

9. The soffit panel of claim 6, wherein the fire-resistant layer comprises a cementitious coating.

10. The soffit panel of claim 6, wherein the fire-resistant layer is magnesium oxide based or magnesium oxychloride based.

11. The soffit panel of claim 6, wherein the fire-resistant layer comprises an intumescent coating.

12. The soffit panel of claim 6, wherein the fire-resistant layer comprises a cloth or fabric.

13. The soffit panel of claim 1, wherein the at least one vent opening comprises a plurality of vent slots.

14. The soffit panel of claim 13, wherein the plurality of vent slots are parallel to each other, and are arranged in several separate groupings on the soffit panel.

15. The soffit panel of claim 13, wherein the plurality of vent slots form a continuous band or single grouping on the soffit panel.

16. The soffit panel of claim 1, wherein the at least one vent opening comprises a plurality of vent holes.

17. The soffit panel of claim 16, wherein the plurality of vent holes are arranged in several separate groupings on the soffit panel.

18. The soffit panel of claim 16, wherein the plurality of vent holes form a continuous band or single grouping on the soffit panel.

19. The soffit panel of claim 16, wherein the plurality of vent holes comprise round or square vent holes.

20. A method of producing the soffit panel of claim 6, comprising the steps of:
providing a base soffit substrate, with a front face and a back face, said base soffit substrate comprising manufactured wood;
on a production line, applying a fire-resistant layer to the back face of the base soffit substrate, wherein the fire-resistant layer covers some or all of the back face;
on the production line, using a multi-blade circular saw, cutting a series of parallel vent openings through the base soffit substrate and the fire-resistant layer; and
on the production line, after the step of cutting, affixing a mesh screen over and to the substrate and fire-resistant layer;
wherein the base soffit substrate, the fire-resistant layer, and the mesh screen are pre-formed into an integral multi-layer arrangement.
